(19) United States
(12) Patent Application Publication
(10) Pub. No.: US 2016/0306545 A1
(43) Pub. Date: Oct. 20, 2016

(54) INTERACTIVE RETICLE FOR A TACTICAL BATTLE MANAGEMENT SYSTEM USER INTERFACE

(71) Applicant: THALES CANADA INC., Toronto (CA)

(72) Inventors: Derek VOISIN, Ottawa (CA); Jean-Francois MOREAU, Ottawa (CA); Darren HUNTER, North Gower (CA); Paul DEGRANDPRE, Lanark Highlands (CA)

(21) Appl. No.: 15/100,362

(22) PCT Filed: Dec. 1, 2014
(86) PCT No.: PCT/CA2014/000858

§ 371 Date: May 31, 2016

Related U.S. Application Data
(60) Provisional application No. 61/910,681, filed on Dec. 2, 2013.

(51) Int. Cl. G06F 3/0488; F41G 9/00; G06F 3/0484; G06F 3/0481; G06F 3/0482

(52) U.S. Cl. CPC G06F 3/04886; G06F 3/04817; G06F 3/0482; G06F 3/04883; G06F 3/04845; G06F 3/04847; F41G 9/00

(57) ABSTRACT

An interactive reticle to be displayed on a user interface displayed on a touchscreen device is disclosed. The interactive reticle comprises a center portion comprising a zone for displaying data and a plurality of icons displayed around the center portion, each of the plurality of icons for executing a corresponding application upon detection of a corresponding finger gesture on a corresponding icon.

### CROSS-REFERENCE TO RELATED APPLICATIONS

This application claims priority on U.S. Patent Application No. 61/910,681, filed on Dec. 2, 2013, which is incorporated herein by reference.

### FIELD

This invention relates to the field of computer user interface. More precisely, this invention pertains to an interactive reticle for a tactical battle management system (TBMS) application.

### BACKGROUND

Command and control, as well as battle management system applications, have been deployed in fighting vehicles for the last twenty years for most fighting forces worldwide. Unfortunately, these applications have struggled to gain user acceptance because they have employed typical desktop/office controls, widgets and layouts that are not conducive to the restrictive and harsh operation environment for inland-force vehicles.

Attempts have been made to address the inherent vehicle-based usability issues by adjusting the typical desktop/office controls and layouts, but these applications still have not addressed fundamental flaws.

Another issue is the fact that, in such software, many options are available, and it is key for a user to be able to quickly access these options with minimum effort. Moreover, memorization of controls is also key for these types of applications.

In fact, attempts have used typical rectangular controls and layouts in a big-button fashion to address the interface issues. These solutions have typically been adaptations of desktop applications within a mobile fighting vehicle. These applications do not focus on a space-constrained, rough-use (rough-terrain) mobile vehicle and quick interaction (mini-step user interaction).

It is therefore an object of this invention to overcome at least one of the above-identified drawbacks.

### BRIEF SUMMARY

According to one aspect, there is disclosed an interactive reticle to be displayed on a user interface displayed on a touchscreen device, the interactive reticle comprising a center portion comprising a zone for displaying data; a plurality of icons displayed around the center portion, each of the plurality of icons for executing a corresponding application upon detection of a corresponding finger gesture on a corresponding icon.

In accordance with an embodiment, the interactive reticle further comprises an interactive reticle moving zone surrounding at least one part of the plurality of icons displayed around the center portion, the interactive reticle moving zone for displacing the interactive reticle in the user interface upon detection of a given finger gesture on the interactive reticle moving zone.

In accordance with an embodiment, the given finger gesture on the interactive reticle moving zone comprises a long touch made until a desired location for the interactive reticle in the user interface is reached.

In accordance with an embodiment, the plurality of icons comprises at least one icon associated with directional pan arrows for moving the interactive reticle in the user interface, further wherein the corresponding gesture on the at least one icon associated with directional pan arrows comprises a touch gesture.

In accordance with an embodiment, each touch gesture on an icon associated with directional pan arrows causes the interactive reticle to move accordingly by one increment.

In accordance with an embodiment, the center portion comprises distance markers.

In accordance with an embodiment, at least one of the plurality of icons comprises a graphical representation of a corresponding application.

In accordance with an embodiment, at least one of the plurality of icons comprises a text indicative of a corresponding application.

In accordance with an embodiment, the center portion has a shape selected from a group consisting of a disc and a square.

In accordance with an embodiment, the plurality of icons comprises an icon representative of an application for performing a pan up, an icon representative of an application for requesting an action, an icon representative of an application for requesting/sending action, an icon representative of an application for performing a pan right, an icon representative of an application for performing a zoom, an icon representative of an application for closing the interactive reticle, an icon representative of an application for performing a pan down, an icon representative of an application for performing a selection, an icon representative of an application for executing an application for marking an action, an icon representative of an application for moving left the interactive reticle.

In accordance with an embodiment, a map is displayed in the user interface and the data displayed in the center portion comprises an area of the map.

In accordance with an embodiment, a view of an area is displayed in the user interface and the data displayed in the center portion comprises a portion of the view of the area.

In accordance with an embodiment, the portion of the view of the area is displayed using a user selectable zoom scale.

In accordance with an embodiment, the plurality of icons displayed around the center portion comprises a first-level menu comprising a first portion of icons surrounding the center portion and a second-level menu comprising a second portion of the plurality of icons surrounding at least one given icon of the first portion, the second-level menu is displayed upon detection of a corresponding finger gesture performed on the at least one given icon of the first-level menu.

In accordance with an embodiment, a third-level menu comprising a third portion of icons is displayed around the second-level menu; the third-level menu is displayed upon detection of a corresponding finger gesture performed on the given icon of the second-level menu.

According to another aspect, there is disclosed a method for enabling a user to interact with a user interface displayed on a touchscreen device, the method comprising obtaining an input from a user; displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; detecting a given finger gesture; executing a corresponding application.

In accordance with an embodiment, the user input comprises a press-and-hold gesture.

In accordance with an embodiment, the detecting of a given finger gesture comprises detecting a first given finger gesture performed on a given icon of the plurality of icons; displaying a second-level menu comprising at least one icon around the given icon and detecting a second given gesture performed on a selected icon of the at least one icon of the second-level menu and the corresponding application executed is associated with the selected icon.

In accordance with an embodiment, the detecting of a given finger gesture comprises detecting a first given finger gesture performed on a given icon of the plurality of icons; displaying a second-level menu comprising at least one icon around the given icon; detecting a second given gesture performed on a selected icon of the at least one icon of the second-level menu; displaying a third-level menu comprising at least one icon around the selected icon of the second-level menu; detecting a third given gesture performed on a selected icon of the at least one icon of the third-level menu and the corresponding application executed is associated with the selected icon of the third-level menu.

In accordance with an embodiment, the interactive reticle further comprises an interactive reticle moving zone surrounding at least one part of the plurality of icons displayed around the center portion; the method further comprises detecting a given finger gesture on the interactive reticle moving zone and displacing the interactive reticle in the user interface accordingly.

In accordance with an embodiment, a map is displayed in the user interface and the data displayed in the center portion comprises an area of the map.

In accordance with an embodiment, a view of an area is displayed in the user interface and the data displayed in the center portion comprises a portion of the view of the area.

In accordance with another aspect, there is disclosed a computer comprising a touchscreen device for displaying a user interface to a user; a processor; a memory unit comprising an application for enabling a user to interact with the user interface displayed on the touchscreen device, the application comprising instructions for obtaining an input from the user; instructions for displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; instructions for detecting a given finger gesture and instructions for executing a corresponding application.

In accordance with another aspect, there is disclosed a tactical battle management system comprising a touchscreen device for displaying a user interface to a user; a processor; a memory unit comprising an application for providing a battle management system, the application comprising instructions for obtaining an input from the user; instructions for displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; instructions for detecting a given finger gesture and instructions for executing a corresponding application.

In accordance with another aspect, there is disclosed a storage device for storing programming instructions executable by a processor, which when executed will cause the execution by the processor of method for enabling a user to interact with a user interface displayed on a touchscreen device, the method comprising obtaining an input from a user; displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; detecting a given finger gesture and executing a corresponding application.

An advantage of the interactive reticle disclosed herein is that it takes advantage of muscle memory which helps a user accomplish a workflow faster and with a reduced cognitive load.

Another advantage of the interactive reticle disclosed herein is that it offers a map-in-map function which enables the display of detail context without losing greater context.

Another advantage of the interactive reticle disclosed herein is that it offers a map-in-map function which offers a great degree of precision even in a mobile and harsh environment.

Another advantage of the interactive reticle disclosed herein is that key functions, or applications, are accessible within a limited number of interactions (i.e., three in one embodiment).

Another advantage of the interactive reticle disclosed herein is that it can be used on a space-constrained device.

### BRIEF DESCRIPTION OF THE DRAWINGS

In order that the invention may be readily understood, embodiments of the invention are illustrated by way of example in the accompanying drawings.

FIG. 1A is a screenshot that shows a first embodiment of an interactive reticle displayed on a user interface of a tactical battle management system. The interactive reticle comprises, inter alia, a center portion having a zone for displaying data.

FIG. 1B is a screenshot that shows the first embodiment of the interactive reticle displayed on a user interface, as shown in FIG. 1A, wherein a zoom has been performed in the center portion.

FIG. 2 is a screenshot that shows, inter alia, a second embodiment of an interactive reticle displayed on a user interface. In this embodiment, there is disclosed a first-level menu, a second-level menu and a third-level menu.

FIG. 3 is a screenshot that shows the second embodiment of the interactive reticle displayed on a user interface. In this embodiment, a user has interacted with an icon displayed.

FIG. 4 is a screenshot that shows the second embodiment of the interactive reticle displayed on the user interface in which a second-level menu is displayed following an interaction of the user with an icon displayed in the first-level menu.

FIG. 5A is a screenshot that shows the first embodiment of the interactive reticle displayed on a user interface wherein a user has interacted with an icon labeled “Mark/open.”

FIG. 5B is a screenshot that shows the second embodiment of the interactive reticle displayed on a user interface in which a second-level menu is displayed following an interaction of the user with the icon labeled “Mark/open” in the first-level menu.

FIG. 6 is a screenshot that shows a window displayed following an interaction of the user with an icon labeled “Hostile” displayed on the second-level menu of the interactive reticle shown in FIG. 5B.

FIG. 7A is a screenshot that shows an embodiment of a map displayed in a tactical battle management system application in which a user is looking to select one of the enemy symbols displayed amid a cluster of symbols.

FIG. 7B is a screenshot that shows a map displayed in a tactical battle management system application in which a plurality of the symbols has been de-aggregated following an interaction of the user with a plurality of symbols shown in FIG. 7A.

FIG. 7C is a screenshot that shows an embodiment of the second embodiment of the interactive reticle which appears at a location selected by the user in the map displayed in the tactical battle management system application shown in FIG. 7B.

FIG. 8A is a screenshot that shows the second embodiment of the interactive reticle in which a second-level menu is displayed at the location shown in FIG. 7C, and which is used to mark the location selected in FIG. 7B.

FIG. 8B is a screenshot that shows an embodiment of a window displayed in a user interface of a tactical battle management system application wherein a plurality of menus is displayed for editing data associated with the location selected in FIG. 7B.

FIG. 9A is a screenshot that shows the second embodiment of the interactive reticle displayed on the user interface of a tactical battle management system application in the case where a user has selected a given position and is looking to enter an order associated with the selected position.

FIG. 9B is a screenshot that shows the second embodiment of the interactive reticle displayed on the user interface of a tactical battle management system application wherein the user has interacted with an icon labeled “Orders” and further wherein a second-level menu is displayed as a consequence of the interaction; the second-level menu being associated with the icon labeled “Orders.”

FIG. 10A is a screenshot that shows the second embodiment of the interactive reticle displayed on the user interface of a tactical battle management system application, wherein a third-level menu corresponding to an icon labeled “New” of the second-level menu is displayed. The third-level menu is used for creating a new order associated with the position selected in the interactive reticle.

FIG. 10B shows a window displayed on the user interface of a tactical battle management system application and displayed following an interaction of the user with an icon in the third-level menu for creating an order.

FIG. 11A is a screenshot that shows the second embodiment of the interactive reticle displayed on the user interface of a tactical battle management system application wherein a user has interacted with the icon labeled “Call for fire” of a first-level menu.

FIG. 11B shows a window displayed on the user interface of a tactical battle management system application and displayed following an interaction of a user with an icon labeled “Call for fire” displayed in the first-level menu shown in FIG. 11A.

FIG. 12A is a diagram that shows a UML class diagram of a tactical battle management system user interface.

FIG. 12B is a UML class diagram of the tactical battle management system user interface WPF base classes.

FIG. 13 is a UML class diagram of the tactical battle management system user interface WPF reticle and reticle view model concrete implementation.

FIG. 14 is a flowchart that shows an embodiment for interacting with an interactive reticle to be displayed on a user interface of a tactical battle management system application displayed on a touchscreen device.

FIG. 15 is a block diagram that shows an embodiment of an apparatus in which the interactive reticle of a tactical battle management system application may be displayed on a user interface.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

The term “variation” of an invention means an embodiment of the invention, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus does not limit the term or phrase it explains. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “respective” and like terms mean “taken individually.” Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is,” and thus limits the term or phrase it explains. For example, in the sentence “the computer sends data (i.e., instructions) over the Internet,” the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to,” the mere usage of the phrase “including but not limited to” does not mean that the term “including” means something other than “including but not limited to.”

Various embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

As disclosed below, the invention may be implemented in numerous ways.

With all this in mind, the present invention is directed to an interactive reticle to be displayed on a user interface displayed on a touchscreen device.

In one embodiment disclosed herein, the interactive reticle is part of a tactical battle management system (TBMS) application. However, it should be understood by the skilled addressee that the interactive reticle may be provided in other applications as explained below.

A tactical battle management system is a software-based battle management toolset intended for vehicle-based users who operate at company level of below. The tactical battle management system is intended to enhance the fighting effectiveness of combat vehicles and act as an extension of a weapon system in that vehicle.

More precisely, the tactical battle management system provides a geographic information system centric battle management system with an ability to provide friendly force tracking and basic user communication means (e.g., chat, messages, tactical object exchange).

In fact, the tactical battle management system application is used for enhancing the effectiveness of combat teams by integrating battle map, positional and situational awareness, targeting, fire control, sensor feeds and instant communication tools.

The tactical battle management system application is implemented on a broad range of touchscreen computers in one embodiment.

As further disclosed below, the tactical battle management system application comprises an interactive reticle that enables a user to precisely locate, mark and act on geospatial objects.

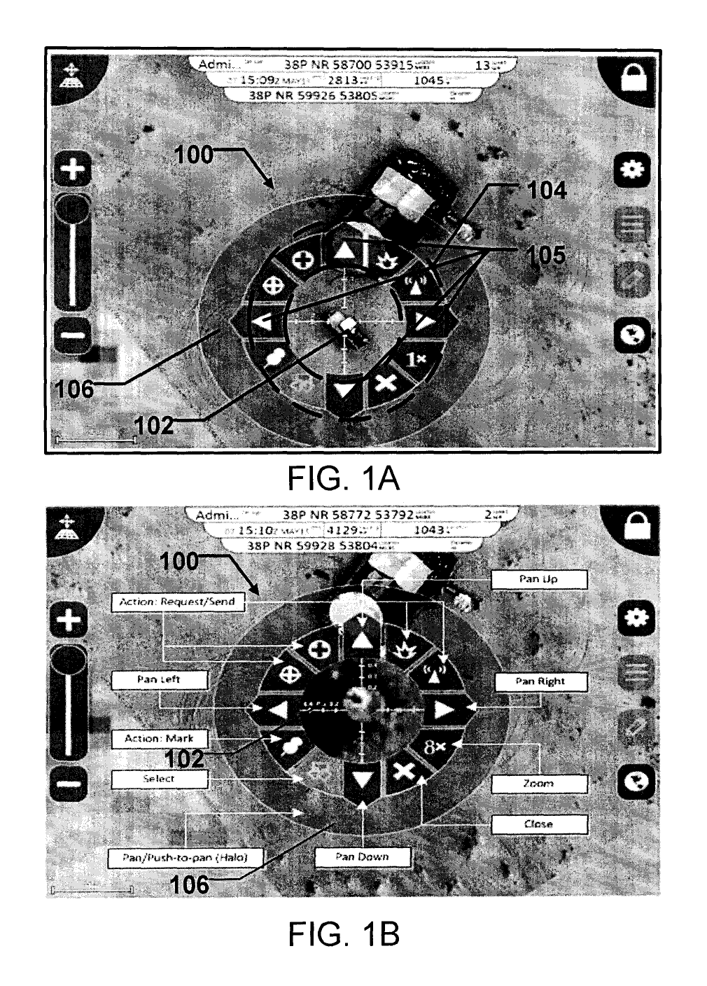

Now referring to FIG. 1A, there is shown a first embodiment of an interactive reticle 100 displayed on a user interface of a tactical battle management system application.

The interactive reticle 100 comprises a center portion 102, a surrounding region 104 comprising a plurality of icons, some of which are identified using reference number 105, displayed around the center portion 102.

Each of the plurality of icons is used for executing a corresponding application (also referred to as a function) upon detection of a corresponding finger gesture on a corresponding icon.

The interactive reticle 100 further comprises an interactive reticle moving zone 106, surrounding at least one part of the surrounding region 104.

The interactive reticle moving zone 106 is used for displacing the interactive reticle 100 on the user interface upon detection of a given finger gesture on the interactive reticle moving zone 106.

In fact, it will be appreciated that a user may displace the interactive reticle 100 on the user interface of the tactical battle system application using either a macro manipulation using a given finger gesture performed on the interactive reticle moving zone 106 or a micro manipulation using a given finger gesture performed on at least one icon associated with directional pan arrows of the plurality of icons or using a given finger gesture, such as a long touch, until a desired location for the interactive reticle 100 is reached on the user interface.

It will be appreciated that the at least one icon associated with directional pan arrows are used to accurately manipulate the location of the interactive reticle 100. The at least one icon associated with directional pan arrows may be repeatedly pressed to move the interactive reticle 100 several steps, also referred to as increments, to refine the exact location intended. In fact, it will be appreciated that the operation is performed to achieve a precise location reference from the interactive reticle 100. It will be appreciated by the skilled addressee that the at least one icon associated with pan arrows enables a reliable and precise relocation of the interactive reticle 100 when the tactical battle management application is used in a vehicle in motion.

It will be appreciated that in one embodiment the tactical battle management system application is designed to display information on a relatively small and low resolution touchscreen display. As a consequence, the interactive reticle 100 may quickly reach the edge of the touchscreen display. After a momentary pause, once the interactive reticle 100 has reached the edge of the touchscreen display, the underlying map will begin to pan in the direction that the interactive reticle 100 is touching. Such interaction is referred to as “push to pan.”

It will be appreciated that the interactive reticle 100 enables an efficient user interaction with a geographic information system touchscreen-based software application by enabling an user to intuitively, accurately and reliably identify and subsequently interact with a geographically referenced point or entity displayed on a map.

It will be appreciated that in one embodiment the center portion 102 of the interactive reticle 100 is displayed with distance markers which indicate a distance between markers displayed.

It will be further appreciated by the skilled addressee that the plurality of icons may be of various types. In one embodiment, an icon is a graphical representation indicative of a corresponding application or function. In an alternative embodiment, an icon comprises a text indicative of the corresponding application.

It will be appreciated that the center portion 102 may be of various shapes. In one embodiment, the center portion 102 has a shape of a disc.

In an alternative embodiment, the center portion has a shape of a square.

Now referring to FIG. 1B, there is shown another embodiment of the interactive reticle 100 shown in FIG. 1A.

In fact, it will be appreciated that, in the embodiment disclosed in FIG. 1B, a zoom has been performed in the center portion 102.

It will be appreciated that having a map-within-map display is of great advantage since it offers a great degree of precision even in mobile and harsh environment.

Also, it will be appreciated that the map-within-map display also offers detail information without losing a greater context.

In an alternative embodiment, a view of an area is displayed in the user interface. The data displayed in the center portion 102 comprises a portion of the view of the area.

It will be appreciated that in one embodiment the interactive reticle 100 has user selectable zoom scales. A user may therefore perform a zoom in/out in the center portion 102. It will be appreciated by the skilled addressee that this provides an increased level of details on the map and also enables the user to more accurately identify a location under the interactive reticle 100 such as the corner of a building for instance.

It will be appreciated that the surrounding region 104 comprises a plurality of icons, each icon corresponding to a given application or function. For instance, the plurality of icons comprises an icon representative of an application for performing a pan up, an icon representative of an application for requesting an action, an icon representative of an application for requesting/sending action, an icon representative of an application for performing a pan right, an icon representative of an application for performing a zoom, an icon representative of an application for closing the interactive reticle 100, an icon representative of an application for performing a pan down, an icon representative of an application for performing a selection, an icon representative of an application for executing an application for marking an action, an icon representative of an application for moving left the interactive reticle.

The skilled addressee will appreciate that various alternative embodiments may be provided for the plurality of icons depending on an application sought.

As a matter of fact, it will be appreciated that the plurality of icons may depend on the nature of the application in which the interactive reticle 100 is used.

It will be appreciated that having the plurality of icons located in the surrounding region 104 around the center portion 102 is of great advantage since it enables a user to complete intended workflows, while on the move, by allowing the user to stabilize himself/herself against the target mounted terminal and interact with the graphics user interface with minimal hand/finger movement. It will be appreciated that the user is further capable of completing actions through memorization of controls of the plurality of icons and layouts which reduces complete reliance on visual interaction.

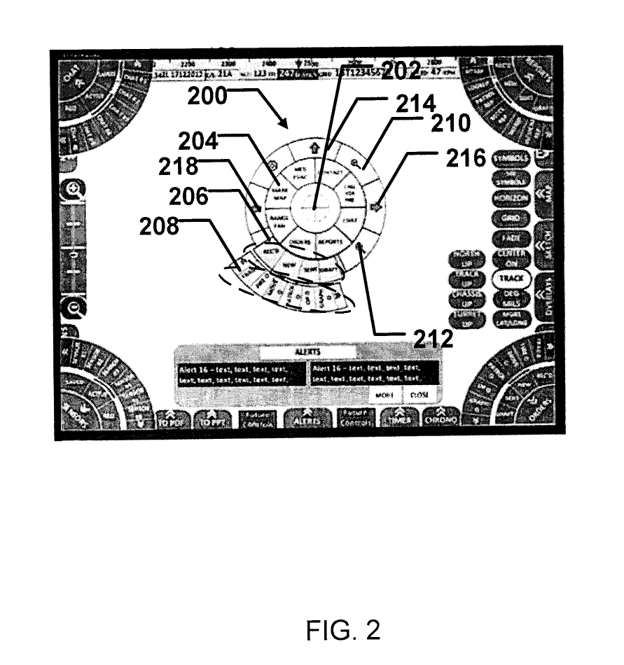

Now referring to FIG. 2, there is shown another embodiment of an interactive reticle.

In this embodiment, the interactive reticle 200 comprises a plurality of icons, each associated with a given application or function, such as an icon representative of an application for moving up the interactive reticle 214, an icon 210 representative of an application for performing a zoom in the center portion of the reticle 202, an icon representative of an application for moving the interactive reticle 200 on the right, an icon representative of an application 212 for zooming out in the center portion 202 of the interactive reticle 200, an icon 204 representative of an application for marking the map, an icon 218 representative of an application for moving the interactive reticle 200 on the left, and an icon representative of an application for executing an order. It will be therefore appreciated that in the embodiment where a view of the area is displayed in the user interface, the portion of the view of the area may be displayed using a user-selectable scale.

It will be appreciated that the interactive reticle 200 disclosed in FIG. 2 further comprises a second-level menu 206 and a third-level menu 208.

Each of the second-level menu 206 and the third-level menu 208 comprises a plurality of icons, each of the plurality of icons is representative of a corresponding application. It will be appreciated that, in this embodiment, the second-level menu 206 and the third-level menu 208 are related to the application associated with the icon labeled “Orders.”

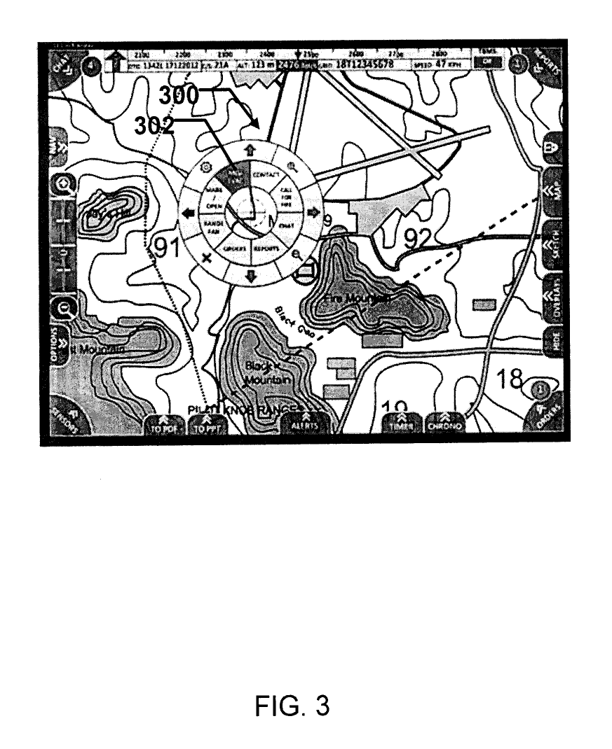

Now referring to FIG. 3, there is shown an embodiment of an interactive reticle 300 in which a user has interacted with an icon 302 associated with a “Medevac” application. It will be appreciated that the interaction may be of various types. In one embodiment, the interaction comprises a single touch from a finger of the user.

It will be appreciated that the tactical battle management system disclosed herein optimizes on usability since key functions are accessible within three interactions.

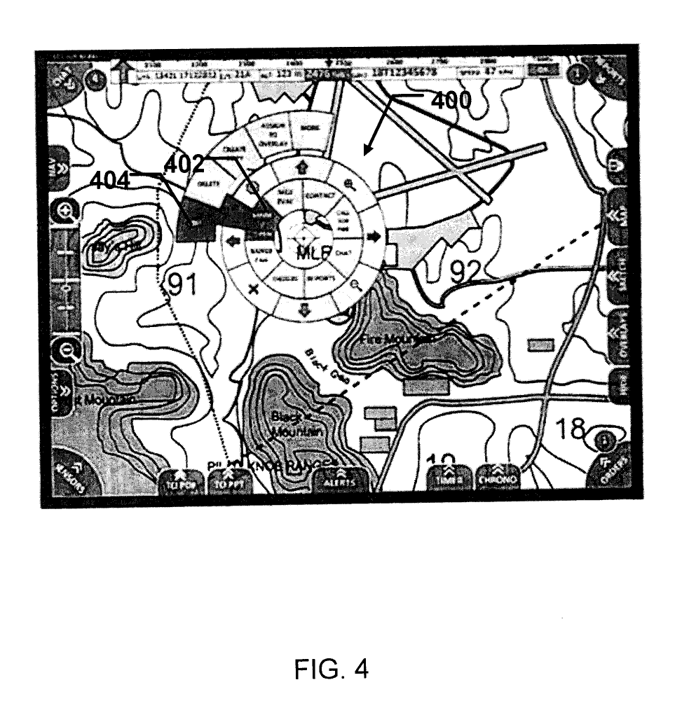

Now referring to FIG. 4, there is shown the interactive reticle 400 shown in FIG. 3, wherein a second-level menu is displayed following an interaction of a user with an icon labeled “Mark/open” 402. In one embodiment, the interaction comprises a single touch from a finger of the user. It will be appreciated that the second-level menu displayed comprises a plurality of icons, each respectively labeled “Edit,” “Delete,” “Create copy,” “Assign to overlay,” and “More,”

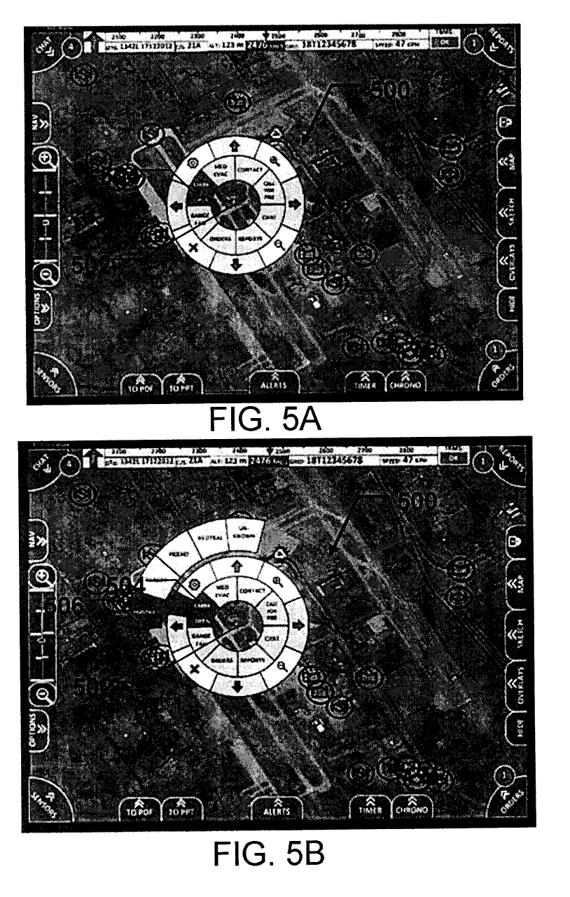

Now referring to FIG. 5A, there is shown an embodiment of the interactive reticle 500 wherein a user has interacted with an icon labeled “Mark/open” 504. Again, it will be appreciated that in one embodiment, the interaction comprises a single touch from a finger of the user.

Now referring to FIG. 5B, there is shown an embodiment of the interactive reticle 500 wherein a second-level menu is displayed following the interaction of the user with the icon labeled “Mark/open” 504. In one embodiment, the interaction comprises a single touch from a finger of the user.

It will be appreciated that an option may be selected amongst a plurality of options in the second-level menu.

More precisely, it will be appreciated that in this embodiment the user has interacted with the icon labeled “Hostile” 506 by performing a given finger gesture on the icon labeled “Hostile” 506. The icon labeled “Hostile” 506 is one of a plurality of icons displayed in the second-level menu which comprises also an icon labeled “Target,” an icon labeled “Friend,” an icon labeled “Neutral” and an icon labeled “Unknown.”

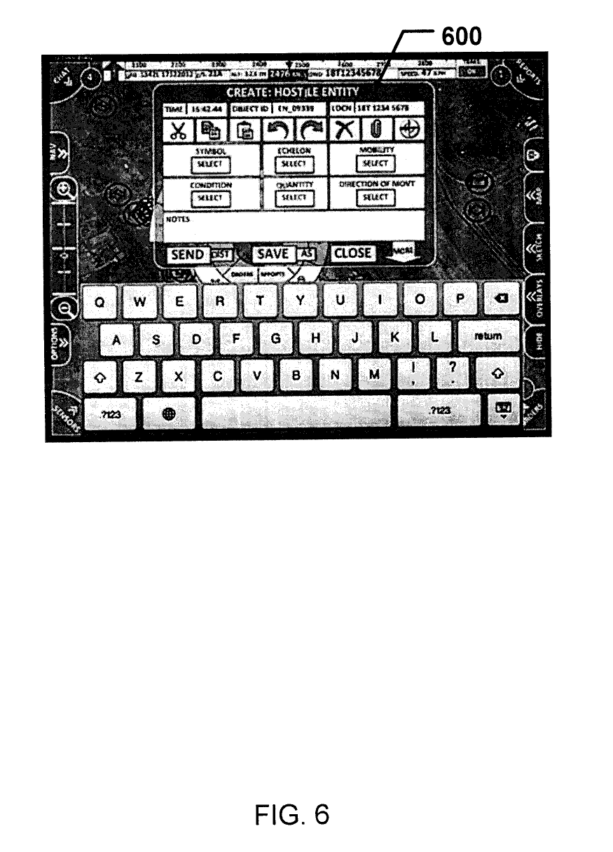

Now referring to FIG. 6, there is shown an embodiment of a menu 600 displayed on a user interface of the tactical battle management system and for entering additional information about the entity.

It will be appreciated that the user may skip the information field and either save, save as, send or manage the “Dist” for the created entity.

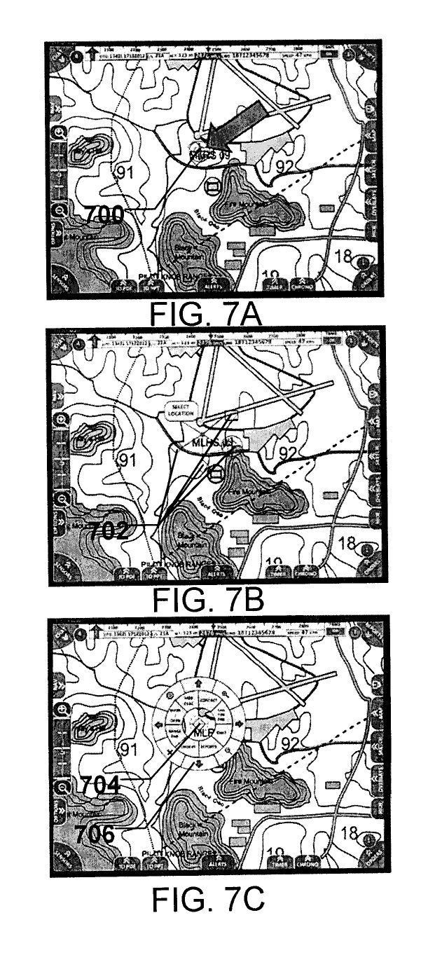

Now referring to FIG. 7A, there is shown a location 700 displayed in a user interface in which the user may want to select one of the enemy symbols displayed amid a cluster of symbols displayed at the location 700.

It will be appreciated that in this embodiment the user may press and hold the screen at the center of the area of the cluster of symbols.

As shown in FIG. 7B and in one embodiment, it will be appreciated that the plurality of symbols 702 may de-aggregate into a fan layout following the interaction of the user at the location 700.

The user may then be able to select a desired symbol (or select a location). It will be appreciated that, in one embodiment, if the user releases the “press and hold” without selecting an object/control within three seconds, the symbols will re-aggregate.

Now referring to FIG. 7C, there is shown the interactive reticle that appears at the location 704 of the selected object or location. The user may then be able to interact with the interactive reticle by interacting, for instance, with icon 706.

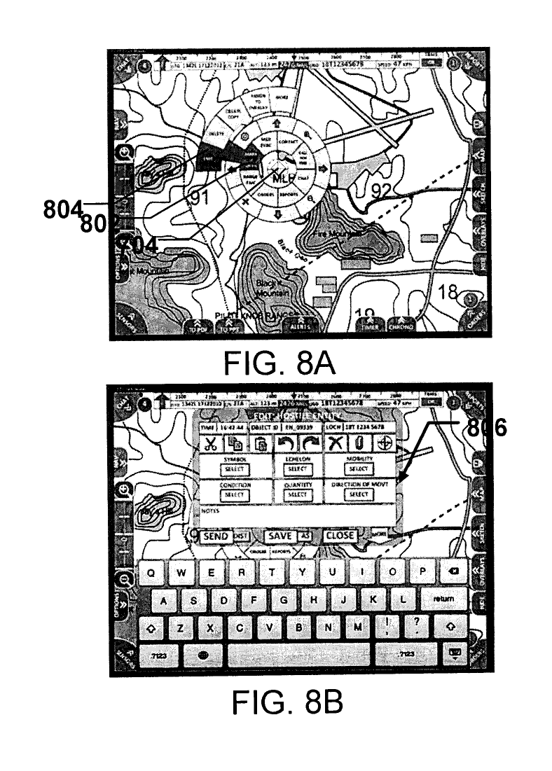

Now referring to FIG. 8A, there is shown an embodiment of the interactive reticle shown in FIG. 7C, wherein the user has interacted with the icon labeled “Mark/open” 802, which as a consequence activates the display of a second-level menu.

The second-level menu comprises a plurality of icons, one of which is an icon labeled “Edit” 804.

Now referring to FIG. 8B, there is shown an embodiment of a window displayed on a user interface following an interaction of the user with the icon labeled “Edit” 804. It will be appreciated that in this window 806, the user may edit and make desired changes and then “Share,” “Save” or “Close” the window 806.

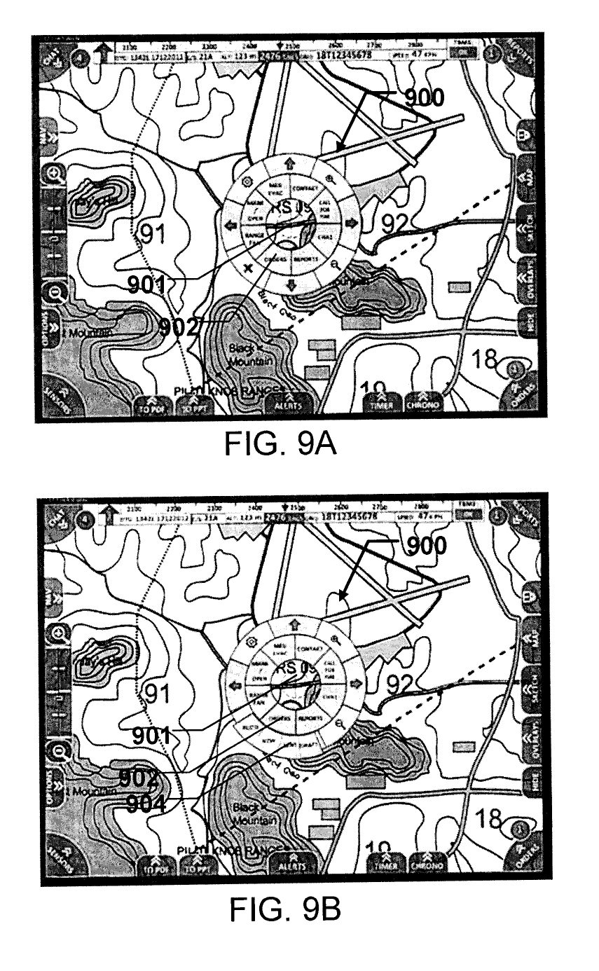

Now referring to FIG. 9A, there is shown an embodiment of an interactive reticle 900. In this embodiment, the user desires to perform an order.

Accordingly, the user will interact with an icon labeled “Orders” 902. Following the interaction with the icon labeled “Orders” 902, and as shown in FIG. 9B, a second-level menu associated with the icon labeled “Orders” 902 will be displayed. It will be appreciated that the second-level menu comprises a plurality of icons, one of which is an icon labeled “Sent” 904.

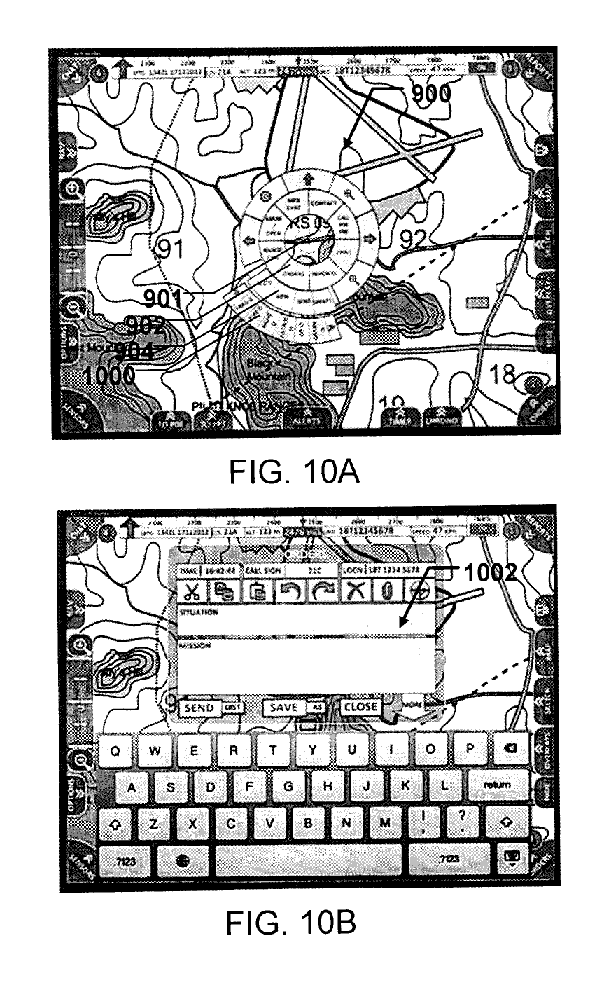

If the user interacts with the icon labeled “New” 904, and as shown in FIG. 10A, a third-level menu may be displayed. It will be appreciated that the third-level menu comprises a plurality of icons.

Now referring to FIG. 10B, there is shown an embodiment of a window displayed on a user interface for opening and completing information associated with an order. Following the entering of information, a user may select one of “Send/send as,” “Save/save as,” or “Close.”

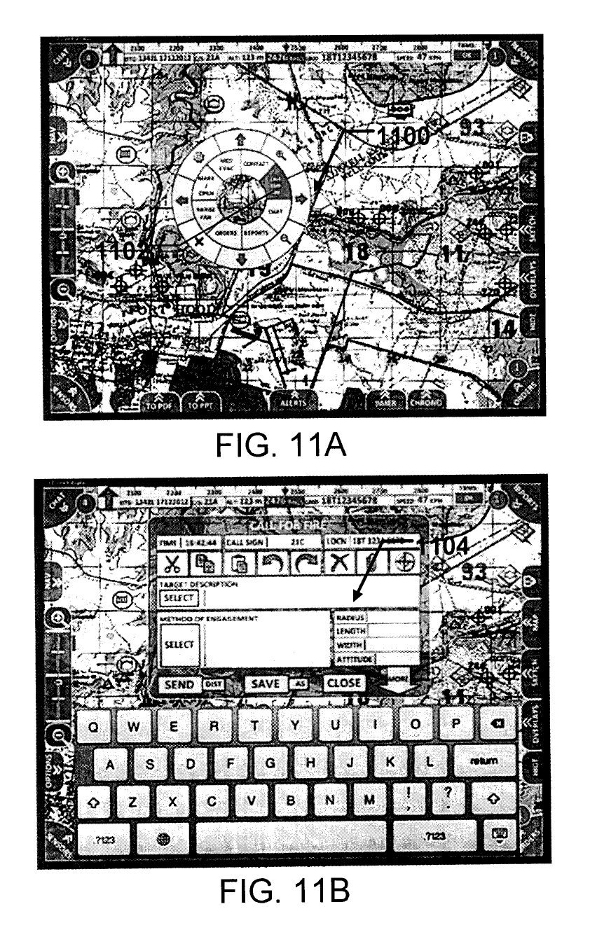

Now referring to FIG. 11A, there is shown a further embodiment of an interactive reticle 1100.

It will be appreciated that the interactive reticle 1100 comprises a plurality of icons, each for executing a corresponding application, one of which is an icon labeled “Call for fire” 1102. The icon labeled “Call for fire” 1102 is associated with an application “Call for fire.”

Now referring to FIG. 11B, there is shown an embodiment of a window displayed on a user interface and associated with the “Call for fire” application. The window 1104 is displayed following an interaction of the user with the icon labeled “Call for fire” 1102.

The skilled addressee will appreciate that various alternative embodiments may be provided for the at least one application.

It will be appreciated that the tactical battle management system application architecture follows in one embodiment a modular design such that components/libraries may be reused.

In one embodiment, the tactical battle management system application is built upon version 4.5 of Microsoft™ .NET™ framework.

It will be appreciated that the tactical battle management system application is specifically designed to run as a 64-bit application. It will be appreciated however that the interactive reticle components are capable of execution as either 32-bit or 64-bit application.

Still in one embodiment, version 5 of C# programming language is used for the development of the interactive reticle. Microsoft™ Visual studio 2012™ Integrated Development Environment (IDE) is also used for the development of the tactical battle management system interactive reticle.

It will be also appreciated that Extensive application Markup Language (XAML) is a markup language that is also used to design and implement the visual aspects of the tactical battle management system interactive reticle.

The skilled addressee will appreciate that various alternative embodiments may be provided.

In one embodiment, there are three principal libraries that constitute the tactical battle management system interactive reticle.

The first library defines portable class library interfaces which describes a generic circle menu, and the menu structure.

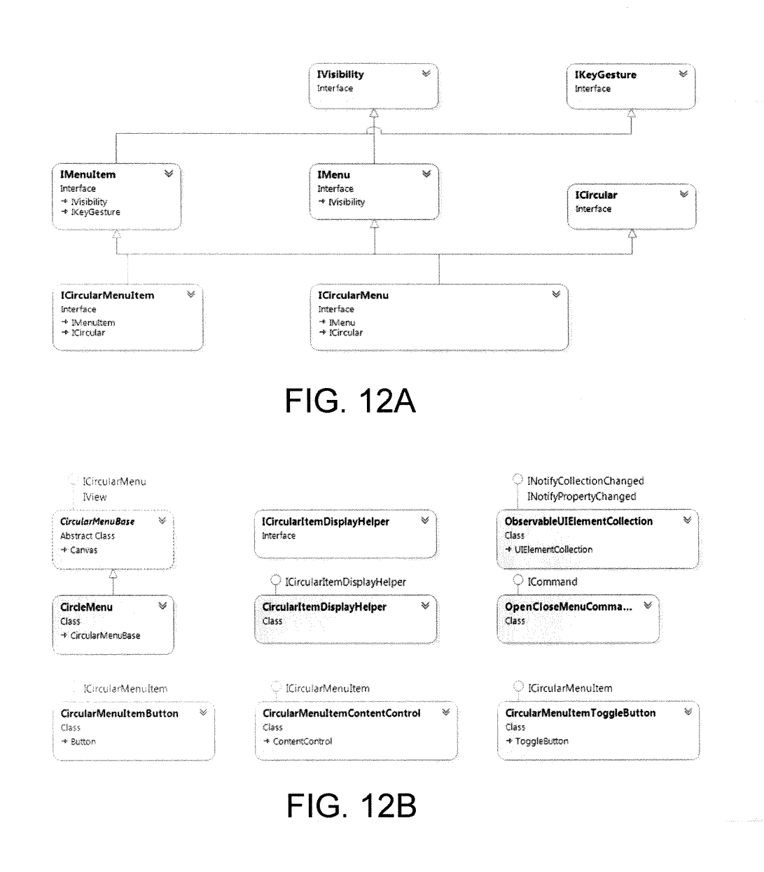

Now referring to FIG. 12A, there is shown an embodiment of a UML class diagram of the tactical battle management system interface reticle interfaces.

It will be appreciated that the second library defines Windows Presentation Foundation (WPF) specific circular menus of the interactive reticle and the layout of the menus and the interaction in the menus.

Now referring to FIG. 12B, there is shown an embodiment of a UML class diagram of the tactical battle management system WPF base classes.

It will be appreciated by the skilled addressee that the third library defines the detailed visual aspects of the circle menu of the interactive reticle and connects the tactical battle management system reticle view elements to the corresponding view models to enable functionality within the reticle.

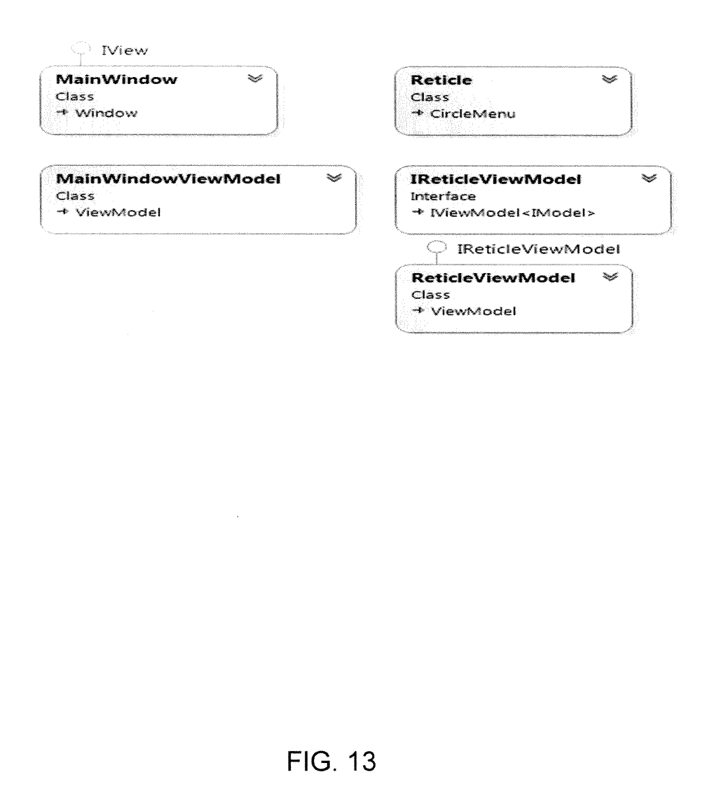

Now referring to FIG. 13, there is shown a UML class diagram of the tactical battle management system WPF interactive reticle and interactive reticle view model concrete implementation.

It will be appreciated that the model-view-view (MVVM) architectural design pattern is adhered to in the tactical battle management system application disclosed herein. This design pattern enables a clear separation of user interface, business logic and data objects.

In one embodiment, the tactical battle management system application uses a customized font for optimized graphic display.

Considering the advanced rendering capabilities, touch interaction support and performance optimization, implementation with Windows Presentation Foundation (WPF) is considered to be the technology appropriate to implement the tactical battle management system reticle. The WPF supports a WPF font cache service which loads fonts and provides optimized access for WPF applications.

In one embodiment, the interactive reticle supports dynamic styling using .NET bindings to support differing colour schemes. In the screen captures traditional army green and yellow themes are displayed. The skilled addressee will appreciate that various alternative embodiments may be provided.

It will be further appreciated that various alternative technologies may be used to implement the tactical battle management system interactive reticle.

These alternative technologies may vary from alternate software development languages such as a Java™ to alternative operating systems for deployment such as Linux™.

It will be further appreciated by the skilled addressee that in one embodiment Microsoft™ Windows™ is selected due to its focus on support for touch-based interaction. In particular, the .NET framework provides advanced touch capabilities and software interpretation which are leveraged heavily within the tactical battle management system interactive reticle, and the .NET framework is designed to operate on the Windows™ operating system.

It will be appreciated that the .NET framework is a set of libraries that provides various functionalities including security, memory, management and exception handling. The .NET framework based software operates within the Common Language Runtime which enables .NET software to support multiple languages and run on various platforms and processor architectures.

Moreover it will be appreciated that WPF supports excellent user interface display capabilities within the .NET framework. WPF inherently supports custom user interface rendering through the use of vector based graphics. Also, WPF supports advanced interpretation of touch screen user interaction such as a multi-touch pinch-to-zoom gesture.

It will be further appreciated that .NET framework provides a long caching service. The WPF font cache service loads fonts and caches fonts to improve the performance of font access. Such an optimization is leveraged in the tactical battle management system interactive reticle through the use of font glyphs.

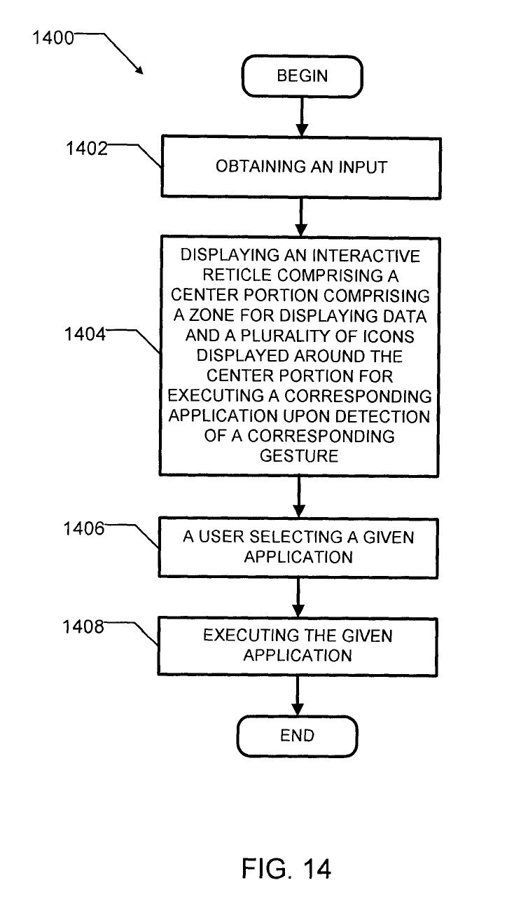

Now referring to FIG. 14, there is shown an embodiment for enabling a user to interact with a user interface displayed on a touchscreen device.

According to processing step 1402, an input is obtained.

It will be appreciated that the input may be obtained according to various embodiments.

In one embodiment, the input is obtained from a user. In such embodiment, the input may be of various types. For instance the input may comprise a press and hold.

Still referring to FIG. 14 and according to processing step 1404, an interactive reticle is displayed.

The interactive reticle comprises a center portion comprising a zone for displaying data and a plurality of icons displayed around the center portion for executing a corresponding application upon detection of a corresponding gesture. In one embodiment, a map is displayed in the user interface. In another embodiment, a view of an area is displayed in the user interface.

In one embodiment, the interactive reticle further comprises an interactive reticle moving zone surrounding at least one part of the plurality of icons displayed around the center portion.

According to processing step 1406, a user is selecting a given application. The given application is selected by the user using an interaction with an icon of the plurality of icons displayed. It will be appreciated that the interaction may comprise a finger gesture.

It will be appreciated that in the embodiment where the interactive reticle comprises an interactive reticle moving zone, the detecting of a given finger gesture on the interactive reticle moving zone may cause the interactive reticle to move accordingly in the user interface.

It will be appreciated that the plurality of icons may be provided in multi-level menus.

As a consequence the selecting of a given application may first comprise performing a first interacting with a given icon on a first-level menu. The interacting with the given icon on the first-level menu may cause a second-level menu to be displayed. The second-level menu displayed may also comprise a corresponding plurality of icons associated with the given icon on the first-level menu. The user may then interact with a given icon of the plurality of corresponding icons of the second-level menu displayed. Depending on the icon with which the user has interacted, a third-level menu may further be displayed. The third-level menu may also comprise a plurality of corresponding icons.

According to processing step 1408, the given application is executed.

It will be appreciated that the application may be executed according to various embodiments.

In one embodiment, the execution of an application may comprise in one embodiment displaying a window. It will be appreciated that various alternative embodiments may be provided.

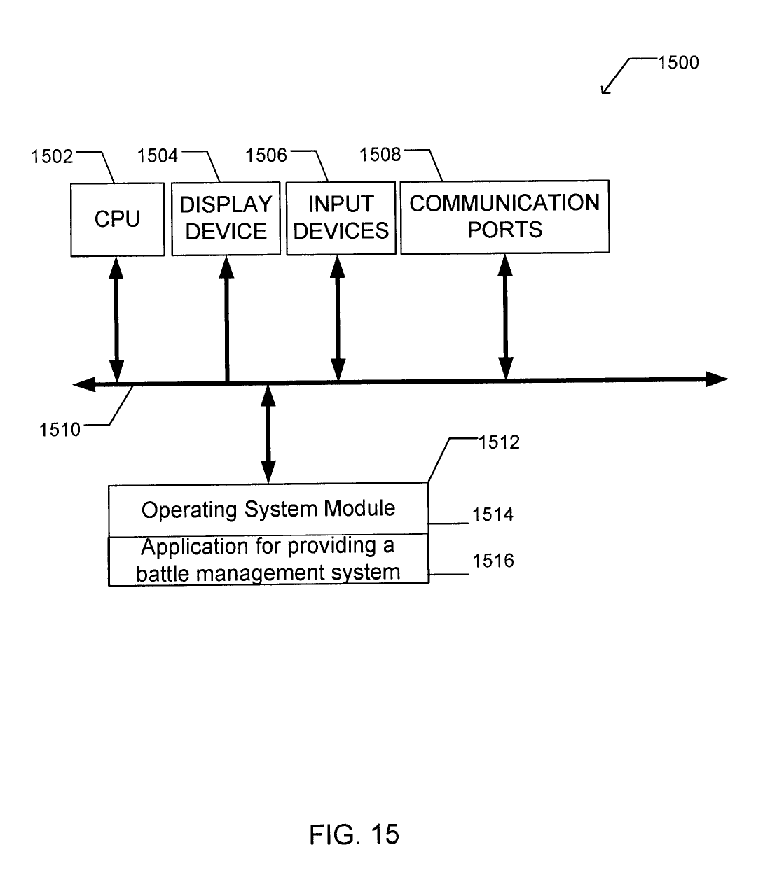

Now referring to FIG. 15, there is shown an embodiment of a system for implementing the tactical battle management system interactive reticle disclosed above, also referred to as a tactical battle management system.

In this embodiment, the system 1500 comprises a CPU 1502, a display device 1504, input devices 1506, communication ports 1508, a data bus 1510 and a memory unit 1512.

It will be appreciated that each of the CPU 1502, the display device 1504, the input devices 1506, the communication ports 1508, and the memory 1512 is operatively interconnected together via the data bus 1510.

The CPU 1502, also referred to as a processor, may be of various types. In one embodiment, the CPU 1502 has a 64-bit architecture adapted for running Microsoft™ Windows™ applications. Alternatively, the CPU 1502 has a 32-bit architecture adapted for running Microsoft™ Windows™ applications.

The display device 1504 is used for displaying data to a user. It will be appreciated that the display 1504 may be of various types. In one embodiment, the display device 1504 is a touchscreen device.

The input devices 1506 may be of various types and may be used for enabling a user to interact with the system 1500.

The communication ports 1508 are used for enabling a communication of the system 1500 with another processing unit. It will be appreciated that the communication ports 1508 may be of various types, depending on the type of processing unit to which it is connected to and a network connection located between the system 1500 and the remote processing unit.

The memory 1512, also referred to as a memory unit, may be of various types. In fact, and in one embodiment, the memory 1512 comprises an operating system module 1514. The operating system module 1514 may be of various types. In one embodiment, the operating system module 1514 comprises Microsoft™ Windows 7™ or Windows 8™.

Alternatively, the operating system module 1514 comprises Linux™.

The memory unit 1512 further comprises an application for providing a battle management system 1516. It will be appreciated that the application for providing a battle management system 1516 may be of various types.

In one embodiment, the application for providing a battle management system 1516 comprises instructions for obtaining an input from the user; instructions for displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; instructions for detecting a given finger gesture and instructions for executing a corresponding application.

It will be appreciated that a storage device is further disclosed for storing programming instructions executable by a processor, which when executed will cause the execution by the processor of method for enabling a user to interact with a user interface displayed on a touchscreen device, the method comprising obtaining an input from a user; displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; detecting a given finger gesture and executing a corresponding application.

Also, it will be appreciated that a computer is disclosed. The computer comprises a touchscreen device for displaying a user interface to a user; a processor; a memory unit comprising an application for enabling a user to interact with the user interface displayed on the touchscreen device. The application comprises instructions for obtaining an input from the user; instructions for displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; instructions for detecting a given finger gesture and instructions for executing a corresponding application.

It will be appreciated that the interactive reticle disclosed herein is of great advantage for various reasons.

In fact, an advantage of the interactive reticle disclosed is that it is readily usable within a high stress and on-the-move environment. The points of contact on the interactive reticle are designed to be sufficiently large to achieve a high success rate even when on-the-move and wearing large winter glove.

Moreover, the interactive reticle disclosed is designed to be intuitive such that the user will either understand the operation and functionality intuitively or be able to learn the operation and functionality.

It will be appreciated that this is achieved by the use of a circular widget which takes advantage of muscle memory which helps users to accomplish their goals faster and with less cognitive load.

Also it will be appreciated that the map-in-map feature offers a great degree of precision even in mobile and harsh environment. It will also be appreciated that the map-in-map feature also offers detail context without losing the greater context, and environment. Also it will be appreciated that the use of familiar concepts to military users such as the reticle with its crosshair measurement aid is also of interest.

It will be also appreciated that another advantage of one of the embodiment of the interactive reticle disclosed herein is that it may be relocated on the user interface using either the interactive reticle moving zone or using an interaction with specific icons or using a given finger gesture such as a long touch at a given location on the user interface.

It will be appreciated that the interactive reticle also provides simplistic means of advanced geographic information system (GIS) functionality.

As a matter of fact, the actions available around the interactive reticle enable the user to perform geographic referenced common operations, such as requesting a medical evacuation from a specific geographic point.

It will be appreciated that the interactive reticle disclosed herein may alternatively be used in various other applications such as for instance in a commercial GPS navigation system, in military and commercial surveillance software, in commercial geographic information system-based applications, such as mapping and imagery hosted in a Web environment, and in commercial, mobile point of sale (POS) systems for the selection of products and transaction completion.

Clause 1. An interactive reticle to be displayed on a user interface displayed on a touchscreen device, the interactive reticle comprising:
a center portion comprising a zone for displaying data;
a plurality of icons displayed around the center portion, each of the plurality of icons for executing a corresponding application upon detection of a corresponding finger gesture on a corresponding icon.

Clause 2. The interactive reticle as claimed in clause 1, further comprising an interactive reticle moving zone surrounding at least one part of the plurality of icons displayed around the center portion, the interactive reticle moving zone for displacing the interactive reticle in the user interface upon detection of a given finger gesture on the interactive reticle moving zone.

Clause 3. The interactive reticle as claimed in clause 2, wherein the given finger gesture on the interactive reticle moving zone comprises a long touch made until a desired location for the interactive reticle in the user interface is reached.

Clause 4. The interactive reticle as claimed in any one of clauses 1 to 3, wherein the plurality of icons comprises at least one icon associated with directional pan arrows for moving the interactive reticle in the user interface, further wherein the corresponding gesture on the at least one icon associated with directional pan arrows comprises a touch gesture.

Clause 5. The interactive reticle as claimed in clause 4, wherein each touch gesture on an icon associated with directional pan arrows causes the interactive reticle to move accordingly by one increment.

Clause 6. The interactive reticle as claimed in any one of clauses 1 to 5, wherein the center portion comprises distance markers.

Clause 7. The interactive reticle as claimed in any one of clauses 1 to 6, wherein at least one of the plurality of icons comprises a graphical representation of a corresponding application.

Clause 8. The interactive reticle as claimed in any one of clauses 1 to 6, wherein at least one of the plurality of icons comprises a text indicative of a corresponding application.

Clause 9. The interactive reticle as claimed in any one of clauses 1 to 8 wherein the center portion has a shape selected from a group consisting of a disc and a square.

Clause 10. The interactive reticle as claimed in any one of clauses 1 to 9, wherein the plurality of icons comprises an icon representative of an application for performing a pan up, an icon representative of an application for requesting an action, an icon representative of an application for requesting/sending action, an icon representative of an application for performing a pan right, an icon representative of an application for performing a zoom, an icon representative of an application for closing the interactive reticle, an icon representative of an application for performing a pan down, an icon representative of an application for performing a selection, an icon representative of an application for executing an application for marking an action, an icon representative of an application for moving left the interactive reticle.

Clause 11. The interactive reticle as claimed in any ones of clauses 1 to 10, wherein a map is displayed in the user interface, further wherein the data displayed in the center portion comprises an area of the map.

Clause 12. The interactive reticle as claimed in any ones of clauses 1 to 10, wherein a view of an area is displayed in the user interface, further wherein the data displayed in the center portion comprises a portion of the view of the area.

Clause 13. The interactive reticle as claimed in clause 12, wherein the portion of the view of the area is displayed using a user selectable zoom scale.

Clause 14. The interactive reticle as claimed in any ones of clauses 1 to 13, wherein the plurality of icons displayed around the center portion comprises a first-level menu comprising a first portion of icons surrounding the center portion and a second-level menu comprising a second portion of the plurality of icons surrounding at least one given icon of the first portion, further wherein the second-level menu is displayed upon detection of a corresponding finger gesture performed on the at least one given icon of the first-level menu.

Clause 15. The interactive reticle as claimed in clause 14, further wherein a third-level menu comprising a third portion of icons is displayed around the second-level menu, further wherein the third-level menu is displayed upon detection of a corresponding finger gesture performed on the a given icon of the second-level menu.

Clause 16. A method for enabling a user to interact with a user interface displayed on a touchscreen device, the method comprising:
obtaining an input from a user;
displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon;
detecting a given finger gesture;
executing a corresponding application.

Clause 17. The method as claimed in clause 16, wherein the user input comprises a press-and-hold gesture.

Clause 18. The method as claimed in any one of clauses 16 to 17, wherein the detecting of a given finger gesture comprises:
detecting a first given finger gesture performed on a given icon of the plurality of icons;
displaying a second-level menu comprising at least one icon around the given icon; and
detecting a second given gesture performed on a selected icon of the at least one icon of the second-level menu;
wherein the corresponding application executed is associated with the selected icon.

Clause 19. The method as claimed in any one of clauses 16 to 17, wherein the detecting of a given finger gesture comprises:
detecting a first given finger gesture performed on a given icon of the plurality of icons;
displaying a second-level menu comprising at least one icon around the given icon;
detecting a second given gesture performed on a selected icon of the at least one icon of the second-level menu;
displaying a third-level menu comprising at least one icon around the selected icon of the second-level menu;
detecting a third given gesture performed on a selected icon of the at least one icon of the third-level menu; and
wherein the corresponding application executed is associated with the selected icon of the third-level menu.

Clause 20. The method as claimed in any one of clauses 16 to 19, wherein the interactive reticle further comprises an interactive reticle moving zone surrounding at least one part of the plurality of icons displayed around the center portion; further comprising detecting a given finger gesture on the interactive reticle moving zone and displacing the interactive reticle in the user interface accordingly.

Clause 21. The method as claimed in any one of clauses 16 to 20, wherein a map is displayed in the user interface, further wherein the data displayed in the center portion comprises an area of the map.

Clause 22. The method as claimed in any one of clauses 16 to 20, wherein a view of an area is displayed in the user interface, further wherein the data displayed in the center portion comprises a portion of the view of the area.

Clause 23. A computer comprising:
a touchscreen device for displaying a user interface to a user;
a processor;
a memory unit comprising an application for enabling a user to interact with the user interface displayed on the touchscreen device, the application comprising:
instructions for obtaining an input from the user;
instructions for displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon;
instructions for detecting a given finger gesture; and
instructions for executing a corresponding application.

Clause 24. A tactical battle management system comprising:
a touchscreen device for displaying a user interface to a user;
a processor;
a memory unit comprising an application for providing a battle management system, the application comprising:
instructions for obtaining an input from the user;
instructions for displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon;
instructions for detecting a given finger gesture; and
instructions for executing a corresponding application.

Clause 25. A storage device for storing programming instructions executable by a processor, which when executed will cause the execution by the processor of method for enabling a user to interact with a user interface displayed on a touchscreen device, the method comprising obtaining an input from a user; displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; detecting a given finger gesture and executing a corresponding application.

1. An interactive reticle to be displayed on a user interface displayed on a touchscreen device, the interactive reticle comprising:
a center portion comprising a zone for displaying data;
a plurality of icons displayed around the center portion, each of the plurality of icons for executing a corresponding application upon detection of a corresponding finger gesture on a corresponding icon; and
wherein the plurality of icons are contextual such that at least one property of a given icon depends on data displayed on the zone for displaying data.

2. The interactive reticle as claimed in claim 1, further comprising an interactive reticle moving zone surrounding at least one part of the plurality of icons displayed around the center portion, the interactive reticle moving zone for displacing the interactive reticle in the user interface upon detection of a given finger gesture on the interactive reticle moving zone.

3. The interactive reticle as claimed in claim 2, wherein the given finger gesture on the interactive reticle moving zone comprises a long touch made until a desired location for the interactive reticle in the user interface is reached.

4. The interactive reticle as claimed in claim 1, wherein the plurality of icons comprises at least one icon associated with directional pan arrows for moving the interactive reticle in the user interface, further wherein the corresponding gesture on the at least one icon associated with directional pan arrows comprises a touch gesture.

5. The interactive reticle as claimed in claim 4, wherein each touch gesture on an icon associated with directional pan arrows causes the interactive reticle to move accordingly by one increment.

6. The interactive reticle as claimed in claim 1, wherein the center portion comprises distance markers.

7. The interactive reticle as claimed in claim 1, wherein at least one of the plurality of icons comprises a graphical representation of a corresponding application.

8. The interactive reticle as claimed in claim 1, wherein at least one of the plurality of icons comprises a text indicative of a corresponding application.

9. The interactive reticle as claimed in claim 1, wherein the center portion has a shape selected from a group consisting of a disc and a square.

10. The interactive reticle as claimed in claim 1, wherein the plurality of icons comprises an icon representative of an application for performing a pan up, an icon representative of an application for requesting an action, an icon representative of an application for requesting/sending action, an icon representative of an application for performing a pan right, an icon representative of an application for performing a zoom, an icon representative of an application for closing the interactive reticle, an icon representative of an application for performing a pan down, an icon representative of an application for performing a selection, an icon representative of an application for executing an application for marking an action, an icon representative of an application for moving left the interactive reticle.

11. The interactive reticle as claimed in claim 1, wherein a map is displayed in the user interface, further wherein the data displayed in the center portion comprises an area of the map.

12. The interactive reticle as claimed in claim 1, wherein a view of an area is displayed in the user interface, further wherein the data displayed in the center portion comprises a portion of the view of the area.

13. The interactive reticle as claimed in claim 12, wherein the portion of the view of the area is displayed using a user selectable zoom scale.

14. The interactive reticle as claimed in claim 1, wherein the plurality of icons displayed around the center portion comprises a first-level menu comprising a first portion of icons surrounding the center portion and a second-level menu comprising a second portion of the plurality of icons surrounding at least one given icon of the first portion, further wherein the second-level menu is displayed upon detection of a corresponding finger gesture performed on the at least one given icon of the first-level menu.

15. The interactive reticle as claimed in claim 14, further wherein a third-level menu comprising a third portion of icons is displayed around the second-level menu, further wherein the third-level menu is displayed upon detection of a corresponding finger gesture performed on the a given icon of the second-level menu.

16. A method for enabling a user to interact with a user interface displayed on a touchscreen device, the method comprising:
obtaining an input from a user;
displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; wherein the plurality of icons are contextual such that at least one property of a given icon depends on data displayed on the zone for displaying data;
detecting a given finger gesture;
executing a corresponding application.

17. The method as claimed in claim 16, wherein the user input comprises a press-and-hold gesture.

18. The method as claimed in claim 16, wherein the detecting of a given finger gesture comprises:
detecting a first given finger gesture performed on a given icon of the plurality of icons;
displaying a second-level menu comprising at least one icon around the given icon; and
detecting a second given gesture performed on a selected icon of the at least one icon of the second-level menu;
wherein the corresponding application executed is associated with the selected icon.

19. The method as claimed in claim 16, wherein the detecting of a given finger gesture comprises:
detecting a first given finger gesture performed on a given icon of the plurality of icons;
displaying a second-level menu comprising at least one icon around the given icon;
detecting a second given gesture performed on a selected icon of the at least one icon of the second-level menu;
displaying a third-level menu comprising at least one icon around the selected icon of the second-level menu;
detecting a third given gesture performed on a selected icon of the at least one icon of the third-level menu; and
wherein the corresponding application executed is associated with the selected icon of the third-level menu.

20. The method as claimed in claim 16, wherein the interactive reticle further comprises an interactive reticle moving zone surrounding at least one part of the plurality of icons displayed around the center portion; further comprising detecting a given finger gesture on the interactive reticle moving zone and displacing the interactive reticle in the user interface accordingly.

21. The method as claimed in claim 16, wherein a map is displayed in the user interface, further wherein the data displayed in the center portion comprises an area of the map.

22. The method as claimed in claim 16, wherein a view of an area is displayed in the user interface, further wherein the data displayed in the center portion comprises a portion of the view of the area.

23. A computer comprising:
a touchscreen device for displaying a user interface to a user;
a processor;
a memory unit comprising an application for enabling a user to interact with the user interface displayed on the touchscreen device, the application comprising:
instructions for obtaining an input from the user;
instructions for displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; wherein the plurality of icons are contextual such that at least one property of a given icon depends on data displayed on the zone for displaying data;
instructions for detecting a given finger gesture; and
instructions for executing a corresponding application.

24. A tactical battle management system comprising:
a touchscreen device for displaying a user interface to a user;
a processor;
a memory unit comprising an application for providing a battle management system, the application comprising:
instructions for obtaining an input from the user;
instructions for displaying an interactive reticle on the user interface; the interactive reticle comprising a center portion comprising a zone for displaying data; a plurality of icons displayed around the center portion, each of the plurality of icons for executing a corresponding application upon detection of a corresponding finger gesture on a corresponding icon; wherein the plurality of icons are contextual such that at least one property of a given icon depends on data displayed on the zone for displaying data;
instructions for detecting a given finger gesture; and
instructions for executing a corresponding application.

25. A storage device for storing programming instructions executable by a processor, which when executed will cause the execution by the processor of method for enabling a user to interact with a user interface displayed on a touchscreen device, the method comprising obtaining an input from a user; displaying an interactive reticle on the user interface;
the interactive reticle comprising a center portion comprising a zone for displaying data; a plurality of icons displayed around the center portion, each of the plurality of icons for executing a corresponding application upon detection of a corresponding finger gesture on a corresponding icon; wherein the plurality of icons are contextual such that at least one property of a given icon depends on data displayed on the zone for displaying data; detecting a given finger gesture and executing a corresponding application.
